(19) United States
(12) Patent Application Publication
(10) Pub. No.: US 2025/0313235 A1
(43) Pub. Date: Oct. 9, 2025

(54) ENHANCED DETECTION AND VEHICLE RISK MITIGATION MEASURES RELATED TO DRIVER HEALTH

(71) Applicant: GM GLOBAL TECHNOLOGY OPERATIONS LLC, Detroit, MI (US)

(72) Inventors: Dontreal THOMAS, Detroit, MI (US); Joseph F. SZCZERBA, Grand Blanc, MI (US); Kathleen Marie SCHUETZ, Royal Oak, MI (US); Sri Krishna Divya PEMMARAJU, Plymouth, MI (US); Daniel S. GLASER, Novi, MI (US)

(21) Appl. No.: 18/628,064

(22) Filed: Apr. 5, 2024

(51) Int. Cl. B60W 60/00; B60W 40/08; B60W 50/00; B60W 50/14; G06V 20/59; G06V 40/16

(52) U.S. Cl. CPC B60W 60/0016; B60W 40/08; B60W 50/0098; B60W 50/14; G06V 20/597; G06V 40/174; B60W 2050/146; B60W 2420/403; B60W 2540/215; B60W 2540/221; B60W 2556/45

(57) ABSTRACT

A vehicle system for detecting and mitigating vehicle risks associated with heath conditions of a driver in a vehicle, includes a plurality of sensors configured to monitor a driver in the vehicle, and a control module in communicate with the plurality of sensors. The control module is configured to receive data from at least one of the plurality of sensors indicative of a condition associated with the driver, detect whether a health risk of the driver is present based on the received data, and in response to detecting the health risk of the driver, determine a mitigating response for the vehicle from a plurality of defined mitigating responses based on the detected health risk. Other example vehicle systems and methods for detecting and mitigating vehicle risks associated with heath conditions of a driver in a vehicle are also disclosed.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to detection and vehicle risk mitigation measures related to driver health.

Vehicles sometimes include driver monitoring sensors and a driver assistance system to assist the driver based in part on feedback from the sensors. For example, the sensors may include a camera monitoring facial features (e.g., eyes, head orientation, etc.) of the driver, a lane departure sensor monitoring driving characteristics of the driver, etc. In some cases, the driver assistance system may be activated to provide vehicle control based on the monitoring of the driver.

### SUMMARY

A vehicle system for detecting and mitigating vehicle risks associated with heath conditions of a driver in a vehicle, includes a plurality of sensors configured to monitor a driver in the vehicle, and a control module in communicate with the plurality of sensors. The control module is configured to receive data from at least one of the plurality of sensors indicative of a condition associated with the driver, detect whether a health risk of the driver is present based on the received data, and in response to detecting the health risk of the driver, determine a mitigating response for the vehicle from a plurality of defined mitigating responses based on the detected health risk.

In other features, the control module is configured to receive a medical profile of the driver indicative including one or more predetermined health risks associated with the driver and one or more preferred mitigating responses to the one or more predetermined health risks.

In other features, the plurality of defined mitigating responses includes the preferred mitigating responses.

In other features, the control module is configured to detect whether the health risk of the driver is present based on the received data and the one or more predetermined health risks.

In other features, the control module is configured to compare the received data to a defined threshold and detect that the health risk of the driver is present if the received data is greater than or less than the defined threshold.

In other features, the control module is configured to automatically execute the determined mitigating response.

In other features, the vehicle system further includes a display module in communication with the control module. The control module is configured to generate a notification for the display module in response to determining the mitigating response for the vehicle, and the display module is configured to display the notification including the detected health risk of the driver, the determined mitigating response for the vehicle, and an input to select the mitigating response for the vehicle.

In other features, the control module is configured to automatically execute the determined mitigating response if a response to the notification is not received within a defined period of time.

In other features, the plurality of defined mitigating responses for the vehicle includes transmitting an alert to a device external to the vehicle, altering a cabin environment in the vehicle, and activating a driver assistance system in the vehicle.

In other features, the vehicle system further includes a display module in communication with the control module. The control module is configured to determine two or more mitigating responses for the vehicle from the plurality of defined mitigating responses based on the detected health risk and generate a notification for the display module, and the display module is configured to display the notification including the detected health risk of the driver, the determined two or more mitigating responses for the vehicle, and an input to select one of the two or more mitigating responses for the vehicle.

In other features, the plurality of sensors includes at least one first sensor fixed in the vehicle and at least one second sensor movable with the driver of the vehicle.

In other features, the at least one second sensor includes one or more medical devices connected to the driver and configured to monitor a health condition of the driver.

In other features, the at least one first sensor includes one or more monitoring devices configured to monitor a driving condition of the driver.

In other features, the one or more monitoring devices include at least one of a camera configured to monitor at least one of a hand placement of the driver and a facial movement of the driver, and a steering torque sensor configured to monitor a torque applied to a steering wheel in the vehicle.

In other features, the control module is configured to receive environmental data indicative of conditions external to the vehicle and detect whether the health risk of the driver is present based on the received data and the received environmental data.

In other features, a vehicle include the vehicle system.

A method for detecting and mitigating vehicle risks associated with heath conditions of a driver in a vehicle, includes receiving data from at least one of a plurality of sensors indicative of a condition associated with the driver, detecting whether a health risk of the driver is present based on the received data, and in response to detecting the health risk of the driver, determining a mitigating response for the vehicle from a plurality of defined mitigating responses based on the detected health risk.

In other features, the method further includes receiving a medical profile of the driver indicative of one or more predetermined health risks associated with the driver and one or more preferred mitigating responses to the one or more predetermined health risks.

In other features, the plurality of defined mitigating responses includes the preferred mitigating responses.

In other features, detecting whether the health risk of the driver is present includes detecting whether the health risk of the driver is present based on the received data and the one or more predetermined health risks.

In other features, the method further includes automatically executing the determined mitigating response.

In other features, the method further includes displaying a notification including the detected health risk of the driver, the determined mitigating response for the vehicle, and an input to select the mitigating response for the vehicle.

In other features, automatically executing the determined mitigating response includes automatically executing the determined mitigating response if a response to the notification is not received within a defined period of time.

In other features, the plurality of sensors includes at least one first sensor fixed in the vehicle and configured to monitor a driving condition of the driver, and at least one second sensor movable with the driver of the vehicle and configured to monitor a health condition of the driver.

In other features, the plurality of defined mitigating responses for the vehicle includes transmitting an alert to a device external to the vehicle, altering a cabin environment in the vehicle, and activating a driver assistance system in the vehicle.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a block diagram of an example vehicle system including a control module for detecting driver health-related events and generating risk mitigating responses to the detected health-related events, according to the present disclosure;

FIG. 2 is a vehicle including portions of the vehicle system of FIG. 1, according to the present disclosure;

FIG. 3 is a block diagram of an example driver notification generated by the control module of FIG. 1, where the driver notification includes a detected health risk, a determined mitigating response, and selectable inputs for executing or ignoring the mitigating response, according to the present disclosure;

FIG. 4 is a block diagram of another example driver notification generated by the control module of FIG. 1, where the driver notification includes a detected health risk and multiple selectable inputs corresponding to different mitigating response options, according to the present disclosure; and

FIGS. 5-6 are flowcharts of example control processes for detecting driver health-related events and generating risk mitigating responses to the detected health-related events, according to the present disclosure.

In the drawings, reference numbers may be reused to identify similar and/or identical elements.

### DETAILED DESCRIPTION

Vehicle drivers may experience health-related events while driving a vehicle. If a health-related event does occur, the driver may become unable to safely control the vehicle. For example, due to a health-related event, the driver may become inattentive and/or unresponsive. Such scenarios pose a significant risk to the driver, other passengers in the vehicle, and others around the traveling vehicle as the driver may lose control of the vehicle and cause harm to others.

The vehicle systems and methods according to the present disclosure provide solutions for detecting driver health-related events while driving the vehicle and then generating risk mitigating responses to the detected health-related events. For example, the vehicle systems and methods may leverage pre-loaded driver-provided health information (e.g., a medical profile) and feedback from one or more driver sensors to detect a driver health-related event, and then generate one or more risk mitigating responses to that event. In such examples, the driver sensors may include first party (e.g., on-board) sensors fixed and/or otherwise located in the vehicle and third party sensors movable with and/or otherwise attached to the driver of the vehicle. With this configuration, the vehicle systems and methods herein enable the preemptive and accurate detection of risky driver behavior and/or conditions, and the generation of desirable risk mitigating responses, to provide enhanced safeguards to the driver, other passengers in the vehicle, and others around the vehicle as the driver.

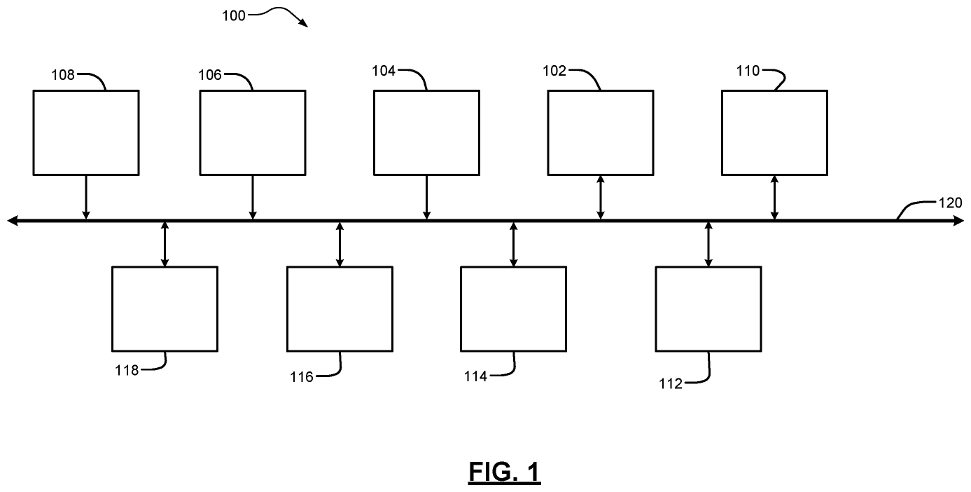

Referring now to FIG. 1, a block diagram of an example vehicle system 100 is presented for detecting and mitigating vehicle risks associated with heath conditions of a driver in a vehicle. As shown in FIG. 1, the vehicle system 100 generally includes a control module 102, multiple sensors in communication with the control module 102, and a memory circuit 110 in communication with the control module 102 for storing one or more pre-loaded driver medical profiles and/or driver preferences. In the example of FIG. 1, the sensors of the vehicle system 100 may optionally include one or more vehicle sensors 104, one or more driver sensors 106, and one or more environment sensors 108. Additionally, the vehicle system 100 may optionally include a driver assistance module 112, an alert module 114, a display module 116, and a cabin environment module 118 in communication with the control module 102.

Although FIG. 1 illustrates the vehicle system 100 as including specific modules and/or sensors, it should be appreciated that the vehicle system 100 and/or other systems herein may include one or more other modules and/or sensors (e.g., having the same or different functionalities) if desired. Additionally, while the vehicle system 100 is shown as including multiple separate modules, it should be appreciated that any combination of the modules (e.g., the control module 102, the driver assistance module 112, the alert module 114, the display module 116, the cabin environment module 118, etc.) and/or the functionality thereof may be integrated into one or more modules.

In the example of FIG. 1, the modules and sensors of the vehicle system 100 may be in communication with each other and may share parameters via a network 120, such as a controller area network (CAN). In such examples, the parameters may be shared via one or more data buses of the network 120. As such, various parameters may be stored in the memory circuit 110 and/or otherwise made available by a given module and/or sensor to other modules and/or sensors via the network 120.

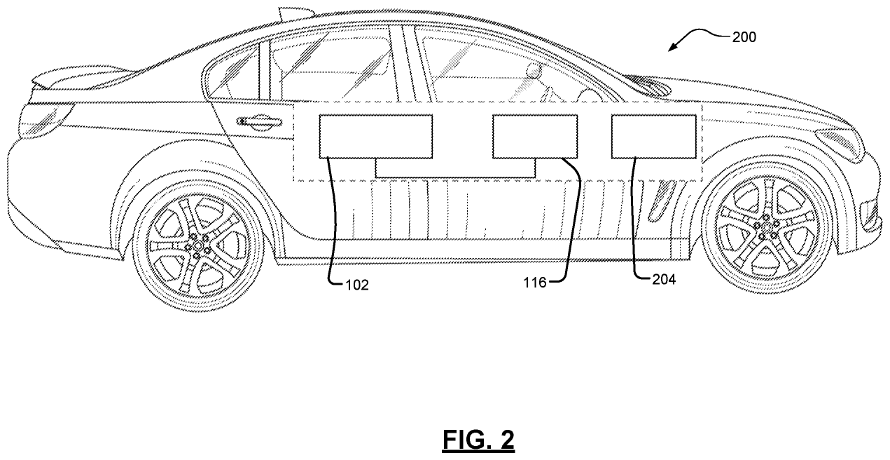

In various embodiments, the vehicle system 100 of FIG. 1 may be employable in any suitable vehicle, such as an electric vehicle (e.g., a pure electric vehicle, a plug-in hybrid electric vehicle, etc.), an internal combustion engine vehicle, etc. Additionally, the vehicle system 100 may be applicable to an autonomous vehicle, a semi-autonomous vehicle, etc. For example, FIG. 2 depicts a vehicle 200 including the control module 102 and the display module 116 of FIG. 1, and one or more sensors 204 (e.g., one or more of the sensors 104, 106, 108 of FIG. 1, etc.) in communication with the control module 102.

With continued reference to FIG. 1, the sensors 104, 106 generally monitor a driver in the vehicle. For example, the vehicle sensor(s) 104 may include any suitable on-board vehicle sensor that is generally fixed in the vehicle and/or otherwise located in the vehicle. In some examples, the vehicle sensor(s) 104 may be referred to as first party sensors that remain in the vehicle. In such examples, the vehicle sensor(s) 104 may include monitoring devices that monitor driving conditions of the driver and provide feedback to the control module 102 indicative thereof. For example, the monitoring devices may include one or more cameras (e.g., cameras of a driver monitoring system) for monitoring a hand placement of the driver, a facial orientation and/or movement of the driver (e.g., eye placement, eye state, drowsiness, emotion, impairment, head orientation, etc.). In such examples, the cameras may be strategically located in the vehicle (e.g., in a dash console, a rearview mirror, etc.) to capture such driver information. Additionally, in some examples, the monitoring devices may include a steering torque sensor for monitoring a torque applied (e.g., an increase and/or a decrease) by the driver to a steering wheel in the vehicle.

Additionally, the driver sensor(s) 106 may include any suitable sensor that is generally movable with and/or otherwise attached to the driver of the vehicle. In some examples, the driver sensor(s) 106 may be referred to as third party sensors that are brought into the vehicle with the driver (e.g., non-vehicle manufacturer sensors). In such examples, the driver sensor(s) 106 may include dedicated medical devices that are generally connected to the driver for monitoring health conditions of the driver. For example, the medical devices may include any suitable type of health monitoring device, such as a glucose sensor for monitoring blood sugar exceedances, a heart sensor for monitoring cardiac anomalies (e.g., pre heart attack conditions), a respiration sensor for monitoring stress/cardiac indicators (e.g., shortness of breath, erratic breathing, etc.), a blood alcohol sensor for monitoring a blood alcohol concentration level and indicating impairment, a temperature sensor for monitoring a temperature and indicating illness/infection, a blood pressure sensor for monitoring stress/cardiac indicators (e.g., high/low blood pressure, etc.), a neurobiomonitor for monitoring brain waves associated with impairment or sleep, etc.

In various embodiments, the control module 102 may connect with the driver sensor(s) 106 brought aboard the vehicle. For example, the control module 102 may connect to the driver sensor(s) 106 via a wireless communication protocol, such as near-field communication, Bluetooth communication, Wi-Fi communication, cellular communication, etc. In such examples, the control module 102 may generally search for, identify the driver sensor(s) 106 when the sensor(s) are nearby, and then connect with the sensor(s). In other examples, the driver may select a user input (e.g., on the display module 116, etc.) to cause the control module 102 to search for nearby driver sensor(s) 106. Regardless, once connected, the driver sensor(s) 106 may provide feedback to the control module 102 indicative of the monitored health conditions of the driver.

In the example of FIG. 1, the environment sensor(s) 108 generally monitor environment conditions external to the vehicle. For example, the environment sensor(s) 108 may monitor the weather outside the vehicle, conditions around the vehicle, etc. For instance, the environment sensor(s) 108 may determine a lighting condition (e.g., bright, dark, etc.) external to the vehicle, if precipitation is present (e.g., rain, snow, etc.), if windy conditions are present, etc. In such examples, the environment sensor(s) 108 may communicate with the control module 102 to provide environmental data indicative of conditions external to the vehicle.

With continued reference to FIG. 1, the control module 102 may detect and mitigate risks associated with health conditions of the driver. For example, the control module 102 may detect whether a health risk of the driver is present. Then, in response to detecting the health risk, the control module 102 may determine a mitigating response for the vehicle as further explained herein.

In various embodiments, the detection of the health risk of the driver may be based in part on sensor data from any one or more of the sensors 104, 106, 108. For instance, and as further explained herein, the control module 102 may receive data from the sensors 104, 106, 108 indicative of conditions associated with the driver, such as driving conditions, medical conditions, and environment conditions.

For example, the control module 102 may detect the vehicle risks and heath conditions of the driver based on other inputs. For example, the control module 102 may receive a medical profile of the driver indicative of one or more predetermined health risks associated with the driver. In such examples, the driver's medical profile may indicate that the driver has a medical condition that may lead to a health-related event. In such examples, the medical profile may provide a medical history associated with the driver. For instance, the health risks of the driver may include increased respiration, unfocused eyes, rapid heart rate drops, pale skin, headaches, hyperglycemia, fainting, etc. The medical profile including the predetermined health risks may be pre-loaded into the vehicle system 100 and stored in the memory circuit 110 if desired.

In various embodiments, the medical profile may be provided as a file, input via a series of questions/confirmations on the display module 116, etc. at any suitable time (e.g., during a setup process of the vehicle, while the vehicle is stopped, etc.). For example, the driver can activate a health feature from a vehicle application on a personal computing device (e.g., a cell phone) or on an infotainment system (e.g., the display module 116, etc.) in the vehicle. Then, the driver may utilize the vehicle application to upload a medical profile and/or provide inputs to generate a medical profile with predetermined health risks (e.g., conditions such as diabetes, risk of cardiac attack, risk of seizures, drowsiness, etc.). Additionally, in some examples, the driver may specify through the vehicle application particular medical devices that should be linked to the control module 102 for monitoring symptoms associated with the predetermined health risks (e.g., blood glucose, heart rate, blood pressure, body movement, etc.).

Then, the control module 102 may detect whether a health risk of the driver is present based on the received data. For example, the control module 102 may detect a health risk of the driver is present based on sensor data from any one or more of the sensors 104, 106, 108 and/or the predetermined health risks provided by the driver. In such examples, the control module 102 may calculate a health risk score based on the received data. Then, if the health risk score is greater than a threshold, the control module 102 may detect the presence of a driver health risk (e.g., a health anomaly associated with the driver). In such examples, the control module 102 may assign different weights to the data received from the sensors 104, 106, 108. In some examples, the pre-loaded medical profile may function as a modifier to driver risk calculations (e.g., assume a higher risk tolerance when detecting unusual changes in bio data from the driver sensor(s) 106, etc.).

In some examples, the control module 102 may detect the presence of a health risk based on health-related thresholds. For instance, each driver sensor 106 may compare the monitored driver data to a threshold, and then transmit an alert signal to the control module 102 indicating a presence of a health risk if the data is greater than or less than the threshold. In other embodiments, the control module 102 may compare each received sensor data (e.g., from the driver sensor(s) 106, etc.) to an associated threshold, and then detect the presence of a health risk if the data is greater than or less than the threshold. In various embodiments, the thresholds may be defined based on, for example, the driver's pre-loaded medical profile, user selection, industry standards, the dedicated medical devices, etc.

Further, in some examples, the control module 102 may identify the health risk of the driver during the detection process. For example, the control module 102 may identify a specific event (e.g., a low glucose level, a cardiac event, etc.) based on the received data from the sensors 104, 106 and/or the predetermined health risks. In some examples, the control module 102 may also identify the severity of the health risk/event. For instance, if the received data from the sensors 104, 106 indicates the driver's glucose is low but not out of the ordinary for the driver (e.g. based on the predetermined health risks), the control module 102 may identify the severity as relatively minor compared to other health risks/events, such as cardiac events, etc.

Next, the control module 102 may determine a mitigating response for the vehicle in response to the detecting the health risk of the driver. For example, in some embodiments, the control module 102 may generate a mitigating response from multiple defined mitigating responses based on the detected health risk. In such examples, the defined mitigating responses may be stored in the memory circuit 110.

In some examples, the control module 102 may receive preferred mitigating responses from the driver. For example, and similar to the medical profile, the driver may pre-load desirable mitigating responses to specific health risks during a setup process of the vehicle, while the vehicle is stopped, etc. In such examples, the driver may provide input on his/her preferred course of action when specific health risks are detected. Such preferred mitigating responses may be received by the control module 102 and stored in the memory circuit 110 as part of the available mitigating responses. Then, when a health risk of the driver is detected and identified, the control module 102 may select one of preferred mitigating responses instead of a generic mitigating response. As such, the pre-loaded mitigating responses provided by the driver may function as a modifier to driver related to risk-mitigation responses (e.g., provide an early warning/indicator of an evaluated health risk, etc.).

In various embodiments, the control module 102 may then provide a notification to the driver of the detected health risk and the determined mitigating response for that health risk. For example, the control module 102 may generate a notification for the display module 116 in response to determining the mitigating response for the vehicle. Then, the display module 116 may display the notification including the detected health risk of the driver, the determined mitigating response for the vehicle, and/or an input to select the mitigating response for the vehicle.

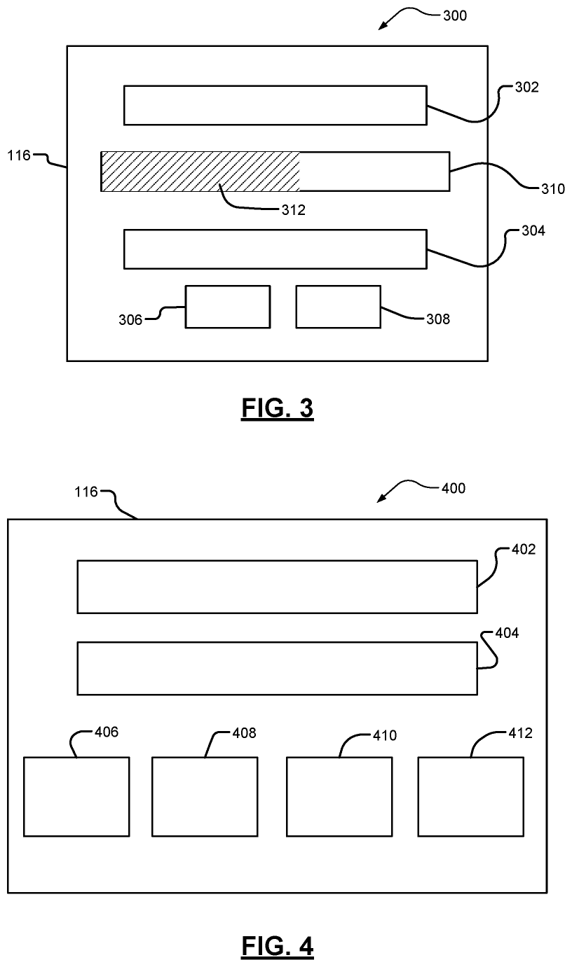

For example, FIG. 3 depicts one example driver notification 300 displayable by the display module 116. As shown, the driver notification 300 includes an output 302 providing the detected health risk of the driver, an output 304 providing the determined mitigating response, and selectable inputs 306, 308 providing options for the driver to either execute or accept (e.g., the input 306) the displayed mitigating response or ignore or decline (e.g., the input 308) the displayed mitigating response. In various embodiments, the driver notification 300 may provide a graphic presenting a pictural representation of the detected health risk of the driver in addition to or alternative to the output 302. Additionally, and as shown in FIG. 3, the driver notification 300 may also include an output 310 providing the severity of the detected health risk. In such examples, the output 310 may include a bar 312 having a changing size to indicate the severity of the detected health risk (e.g., a low severity, a medium severity, a high severity, etc.).

In other examples, the control module 102 of FIG. 1 may generate a notification for the display module 116 that includes multiple mitigating response options for the vehicle. For example, the control module 102 may determine multiple mitigating responses for the vehicle based on the detected health risk and the pre-loaded/preferred mitigating responses from the driver, and then generate a notification for the display module 116. Then, the display module 116 may display the notification including the detected health risk of the driver, the available mitigating responses, and an input to select one of the available mitigating responses.

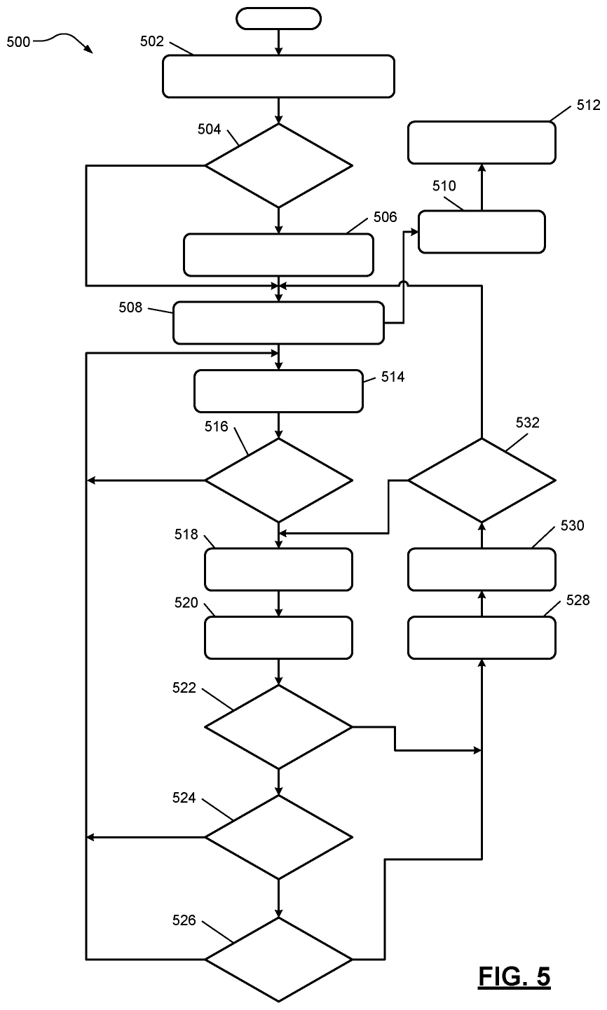

For example, FIG. 4 depicts one example driver notification 400 displayable by the display module 116. As shown, the driver notification 400 includes an output 402 providing the detected health risk or anomaly of the driver (e.g., low blood sugar), an output 404 providing the severity or level of the detected health risk (e.g., 70 mg/dL), and multiple selectable inputs 406, 408, 410, 412 corresponding to different mitigating response options. For example, the input 406 may correspond to a first mitigating response (e.g., stop the vehicle), the input 408 may correspond to a second mitigating response (e.g., display a defined automation relating to the detected health risk), and the input 410 may correspond to a third mitigating response (e.g., call emergency services). Additionally, the input 412 may provide a response option of cancelling the detected health risk. As such, with this configuration, the driver or another passenger in the vehicle may select a desired mitigating response for execution or cancel the detected health risk.

In various embodiments, the control module 102 of FIG. 1 may rely on the selected response option for further learning and training related to the detection of health risks and the generation of mitigating responses. For example, if the driver routinely cancels a detected health risk associated with a low blood sugar level of 90 mg/dl and higher, the control module 102 may not detect and notify the driver of such occurrences in the future.

In some embodiments, the control module 102 may execute the mitigating response in response user input. For example, the control module 102 may execute a selected mitigating response (e.g., one of the inputs 406, 408, 410 of FIG. 4) or may execute a mitigating response if instructed to do so (e.g., the input 306 of FIG. 3 is selected).

In other embodiments, the control module 102 may execute the mitigating response if no user input is provided. For example, the control module 102 may initiate a timer in response to generating and/or displaying a notification including a mitigating response. If a response to the notification is not received within a defined period of time (e.g., two seconds, three seconds, five seconds, etc.), the control module 102 may automatically execute the determined mitigating response.

In still other embodiments, the control module 102 may automatically execute the determined mitigating response without generating a driver notification. For example, if the control module 102 detects a severe health risk (e.g., a cardiac event, etc.) based on the sensor data, the control module 102 may automatically execute the determined mitigating response. In such examples, the control module 102 may, for example, transmit a signal to the cabin environment module 118 to alter a cabin environment in the vehicle (e.g., change a HVAC setting, a speaker volume setting, an interior light setting, etc.). In other examples, the control module 102 may transmit a signal to the alert module 114 to generate/transmit an alert to a device external to the vehicle (e.g., call emergency services, call/alert family/friend, etc.). In still other examples, the control module 102 may transmit a signal to the driver assistance module 112 to activate a driver assistance system (e.g., autonomous driving, etc.) in the vehicle. In such examples, the driver assistance system may control the vehicle to pull over, proceed to the nearest hospital, etc.

In various embodiments, the vehicle system 100 may include improved system accuracy with pre-entered and real time health data, thereby resulting in more timely and relevant mitigation response options. As example only, a user may have recently acquired a vehicle. During a setup process that vehicle, the user may be prompted to provide health information for driving assistance and safety purposes, such a medical profile and preferred mitigating responses as explained herein. As a diabetic with blood sugar issues, the user discovered that his/her glucose monitoring device can be integrated with the control module 102 of the vehicle. As such, during setup, the user may specify the driving behaviors the vehicle should be sensitive to (e.g., vehicles risks, etc.) and the glucose levels he wants to be alerted about (e.g., preferred mitigating responses, etc.). Then, at a later time while driving, the glucose level of the user may drop resulting in erratic and delayed driving behaviors. Throughout this drive, the control module 102 may generate notifications for display on the display module 116 expressing concern for the user's glucose level. With such notification, the user may navigate to a nearby gas station to purchase food to increase his/her glucose level. If, however, the glucose level falls below a defined threshold, a notification may be presented providing the user with several mitigating response options, including executing a set of pre-determined automations such as the activation of a driver assistance system and contacting emergency services.

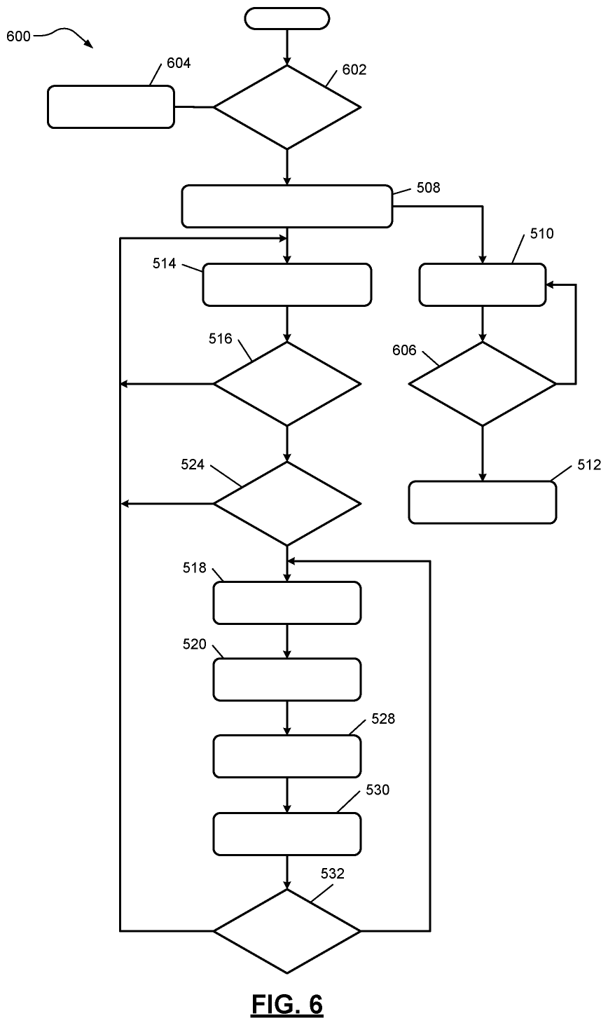

FIGS. 5-6 illustrate example control processes 500, 600 employable by the vehicle system 100 of FIG. 1. Specifically, and as further explained below, the control processes 500, 600 of FIGS. 5-6 relate to detecting and mitigating vehicle risks associated with heath conditions of a driver in a vehicle (e.g., the vehicle 200 of FIG. 2). Although the example control processes 500, 600 are described in relation to the vehicle system 100 of FIG. 1, any one of the control processes 500, 600 may be employable by another suitable system.

In FIG. 5, the control process 500 begins at 502 where the control module 102 receives health information and vehicle action preferences from a driver. For example, and as explained herein, the control module 102 may receive and store a pre-loaded medical profile for the driver and preferred mitigating responses from the driver. This information may be provided during, for example, an initial setup process for the vehicle or sometime later while the vehicle is stopped. The control process 500 then proceeds to 504.

At 504, the control module 102 determines whether any driver sensors are detected. For example, the control module 102 may generally search for and identify the driver sensor(s) 106 of FIG. 1 when the sensor(s) are nearby, as explained above. If no driver sensors are detected, control proceeds to 508. If, however, any driver sensors are detected, control proceeds to 506 where the control module 102 connects (e.g., wirelessly connects) with the detected driver sensors and then to 508.

At 508, the control module 102 receives data from various sensors in the vehicle and/or connected to the control module 102. For example, and as explained herein, the control module 102 may receive data from one or more cameras, steering torque sensors and/or other suitable vehicle sensors (e.g., the vehicle sensor(s) 104 of FIG. 1), and/or from the connected driver sensors (e.g., the driver sensor(s) 106 of FIG. 1) in step 506. In various embodiments, the collection of sensor data may occur while the vehicle is in motion (e.g., while the driver drives the vehicle, etc.) and repeatedly over time (e.g., periodically, etc.). As such, the control module 102 may continually receive data from the sensors while the vehicle is being driven. Control then proceeds to 510 and 514.

At 510, the control module 102 stores the data or at least a portion thereof received from the sensors. In various embodiments, the control module 102 may store this data in the memory circuit 110 of FIG. 1 or another suitable location. Then, control proceeds to 512, where the control module 102 may generate and/or update a user health report. For example, the control module 102 may periodically generate a health report for the driver based on the stored data. In various embodiments, the control module 102 may generate the health report at any suitable interval, such as daily, weekly, monthly, quarterly, yearly, etc. In some examples, the generated health report may be transmitted to the driver's personal computing device and/or otherwise made available to the driver. If desired, the driver may provide the health report to physicians so that the physician can monitor the driver's health and identify problematic health trends over time.

At 514, the control module 102 compares the received data to defined thresholds. For example, and as explained above, the control module 102 may compare each received data value (e.g., from the driver sensor(s) 106, etc.) to an associated threshold. In such examples, the thresholds may be defined based on, for example, the driver's pre-loaded medical profile, user selection, industry standards, etc. Control then proceeds to 516, where the control module 102 determines whether any driver health risk is detected based on the comparison between the received data and the defined thresholds. If yes, control proceeds to 518. Otherwise, if no driver health risk is detected, control returns to 514.

At 518, the control module 102 determines a mitigating response for the vehicle. For example, and as explained above, the control module 102 may generate a mitigating response from multiple defined mitigating responses based on the detected health risk. In such examples, the multiple defined mitigating responses may include preferred mitigating responses provided by the driver at step 502. Then, control proceeds to 520.

At 520, the control module 102 generates a notification for display to the driver. In such examples, the generated notification may be displayed by the display module 116 of FIG. 1. For example, and as explained above, the control module 102 may generate a notification (e.g., the notification 300 of FIG. 3) providing the detected health risk of the driver, the determined mitigating response, and selectable inputs to either execute or ignore the mitigating response. Control then proceeds to 522.

At 522, the control module 102 determines whether the determined mitigating response has been accepted by the driver. For example, the control module 102 may receive a signal indicating that the driver selected an input on the notification to execute the determined mitigating response. If the driver has accepted the mitigating response provided by the notification, control proceeds to 528. Otherwise, control proceeds to 524.

At 524, the control module 102 determines whether the detected health risk of 516 is urgent. For example, and as explained above, the control module 102 may identify the severity or urgency of the health risk/event (e.g., low blood sugar, cardiac event, etc.) based on the received data from the sensors and/or the health information provided by the driver at step 502. If the detected health risk is not determined to be urgent, control returns to 514. If, however, the detected health risk is determined to be urgent, control proceeds to 526.

At 526, the control module 102 determines whether the determined mitigating response has been refused by the driver. If no, control proceeds to 528. If yes, control returns to 514. For example, if the driver has not accepted the mitigating response provided by the notification (in step 522) and the detected health risk is urgent (in step 524), the control module 102 may set a timer. If the control module 102 does not receive a signal indicating that the driver selected an input on the notification to ignore the determined mitigating response within a defined period of time set by the timer, control proceeds to 528. Otherwise, if a signal is received indicating that the driver selected an input to ignore the determined mitigating response within the defined period, control returns to 514.

At 528, the control module 102 executed the determined mitigating response. For example, and as explained above, the control module 102 may transmit a signal to the cabin environment module 118 to alter a cabin environment in the vehicle (e.g., change a HVAC setting, a speaker volume setting, an interior light setting, etc.), transmit a signal to the alert module 114 to generate/transmit an alert to a device external to the vehicle (e.g., call emergency services, call/alert family/friend, etc.), transmit a signal to the driver assistance module 112 to activate a driver assistance system in the vehicle, etc. Control then proceeds to 530, where the control module 102 continues to receive data from the sensors (e.g., the vehicle sensor(s) 104 and the driver sensor(s) 106 of FIG. 1) monitoring the driver. Control then proceeds to 532.

At 532, the control module 102 determines whether the detected health risk (in step 516) is escalating. For example, the control module 102 may compare previous sensor data (in step 508) to more recent sensor data (in step 530) and then determine whether the health risk of the driver is increasing based on the comparison. If the detected health risk is escalating, control returns to 518. Otherwise, if the detected health risk is not escalating, control returns to 508.

The control process 600 of FIG. 6 is similar to the control process 500, but where health information and vehicle action preferences from a driver are not pre-loaded or otherwise provided to the control module 102. For example, in FIG. 6, the control process 600 begins at 602 where the control module 102 determines if a health feature is enabled to provide a medical profile and vehicle action preferences. For example, and as explained above, the driver can activate a health feature from a vehicle application on a personal computing device or on an infotainment system (e.g., the display module 116, etc.) in the vehicle. If the health feature is enabled (or activated), control proceeds to 604 where the control module 102 initiates a pre-loaded health sequence for allowing the driver to upload a medical profile and/or provide inputs to generate a medical profile with predetermined health risks as explained above. Otherwise, if the health feature is not enabled (or not activated), control proceeds to 510, 514, 516 as explained above relative to the control process 500 of FIG. 5.

After storing the data or at least a portion thereof received from the sensors in 510, control proceeds to 606 where the control module 102 determines if user has requested a health report and if so, an interval for the health report. If yes, control proceeds to 512 as explained above relative to the control process 500 of FIG. 5. Otherwise, control returns to 510.

After determining whether any driver health risk is detected based on the comparison between the received data and the defined thresholds in 516, control proceeds to 524 as explained above relative to the control process 500 of FIG. 5. Then, after determining whether the detected health risk of 516 is urgent in 524, control proceeds to 518, 520, 528, 530, 532 as explained above relative to the control process 500 of FIG. 5.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, JavaScript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A vehicle system for detecting and mitigating vehicle risks associated with heath conditions of a driver in a vehicle, the vehicle system comprising:
a plurality of sensors configured to monitor a driver in the vehicle; and
a control module in communicate with the plurality of sensors, the control module configured to:
receive data from at least one of the plurality of sensors indicative of a condition associated with the driver;
detect whether a health risk of the driver is present based on the received data; and
in response to detecting the health risk of the driver, determine a mitigating response for the vehicle from a plurality of defined mitigating responses based on the detected health risk.

2. The vehicle system of claim 1, wherein:
the control module is configured to receive a medical profile of the driver indicative including one or more predetermined health risks associated with the driver and one or more preferred mitigating responses to the one or more predetermined health risks; and
the plurality of defined mitigating responses includes the preferred mitigating responses.

3. The vehicle system of claim 2, wherein the control module is configured to detect whether the health risk of the driver is present based on the received data and the one or more predetermined health risks.

4. The vehicle system of claim 1, wherein the control module is configured to compare the received data to a defined threshold and detect that the health risk of the driver is present if the received data is greater than or less than the defined threshold.

5. The vehicle system of claim 1, wherein the control module is configured to automatically execute the determined mitigating response.

6. The vehicle system of claim 1, further comprising a display module in communication with the control module, wherein:
the control module is configured to generate a notification for the display module in response to determining the mitigating response for the vehicle; and
the display module is configured to display the notification including the detected health risk of the driver, the determined mitigating response for the vehicle, and an input to select the mitigating response for the vehicle.

7. The vehicle system of claim 6, wherein the control module is configured to automatically execute the determined mitigating response if a response to the notification is not received within a defined period of time.

8. The vehicle system of claim 1, wherein the plurality of defined mitigating responses for the vehicle includes transmitting an alert to a device external to the vehicle, altering a cabin environment in the vehicle, and activating a driver assistance system in the vehicle.

9. The vehicle system of claim 1, further comprising a display module in communication with the control module, wherein:
the control module is configured to determine two or more mitigating responses for the vehicle from the plurality of defined mitigating responses based on the detected health risk and generate a notification for the display module; and
the display module is configured to display the notification including the detected health risk of the driver, the determined two or more mitigating responses for the vehicle, and an input to select one of the two or more mitigating responses for the vehicle.

10. The vehicle system of claim 1, wherein the plurality of sensors includes at least one first sensor fixed in the vehicle and at least one second sensor movable with the driver of the vehicle.

11. The vehicle system of claim 10, wherein the at least one second sensor includes one or more medical devices connected to the driver and configured to monitor a health condition of the driver.

12. The vehicle system of claim 10, wherein the at least one first sensor includes one or more monitoring devices configured to monitor a driving condition of the driver.

13. The vehicle system of claim 12, wherein the one or more monitoring devices include at least one of a camera configured to monitor at least one of a hand placement of the driver and a facial movement of the driver, and a steering torque sensor configured to monitor a torque applied to a steering wheel in the vehicle.

14. The vehicle system of claim 1, wherein the control module is configured to receive environmental data indicative of conditions external to the vehicle and detect whether the health risk of the driver is present based on the received data and the received environmental data.

15. A vehicle comprising the vehicle system of claim 1.

16. A method for detecting and mitigating vehicle risks associated with heath conditions of a driver in a vehicle, the method comprising:
receiving data from at least one of a plurality of sensors indicative of a condition associated with the driver;
detecting whether a health risk of the driver is present based on the received data; and
in response to detecting the health risk of the driver, determining a mitigating response for the vehicle from a plurality of defined mitigating responses based on the detected health risk.

17. The method of claim 16, wherein:
the method further comprises receiving a medical profile of the driver indicative of one or more predetermined health risks associated with the driver and one or more preferred mitigating responses to the one or more predetermined health risks;
the plurality of defined mitigating responses includes the preferred mitigating responses; and
detecting whether the health risk of the driver is present includes detecting whether the health risk of the driver is present based on the received data and the one or more predetermined health risks.

18. The method of claim 16, further comprising automatically executing the determined mitigating response.

19. The method of claim 18, wherein:
the method further comprises displaying a notification including the detected health risk of the driver, the determined mitigating response for the vehicle, and an input to select the mitigating response for the vehicle; and
automatically executing the determined mitigating response includes automatically executing the determined mitigating response if a response to the notification is not received within a defined period of time.

20. The method of claim 17, wherein:
the plurality of sensors includes at least one first sensor fixed in the vehicle and configured to monitor a driving condition of the driver, and at least one second sensor movable with the driver of the vehicle and configured to monitor a health condition of the driver; and
the plurality of defined mitigating responses for the vehicle includes transmitting an alert to a device external to the vehicle, altering a cabin environment in the vehicle, and activating a driver assistance system in the vehicle.
